(19) United States
(12) Patent Application Publication
(10) Pub. No.: US 2014/0111629 A1
(43) Pub. Date: Apr. 24, 2014

(54) SYSTEM FOR DYNAMIC PROJECTION OF MEDIA

(71) Applicants: Margaret Morris, Portland, OR (US); Douglas M. Carmean, Beaverton, OR (US)

(72) Inventors: Margaret Morris, Portland, OR (US); Douglas M. Carmean, Beaverton, OR (US)

(21) Appl. No.: 13/795,295

(22) Filed: Mar. 12, 2013

Related U.S. Application Data
(60) Provisional application No. 61/716,527, filed on Oct. 20, 2012.

(51) Int. Cl. H04N 9/31

(52) U.S. Cl. CPC H04N 9/31
USPC 348/77

(57) ABSTRACT

A system for presenting an image on a user in a social setting includes an image projection system configured to detect the presence of a user via their mobile device when the user comes within a predefined proximity, such as within a real-world social setting (e.g., coffeehouse, bar, club, etc.). The image projection system is further configured to access a social network platform and detect media content associated with the user, particularly media content that the user has shared on the social network platform via their mobile device. The image projection system is further configured to project media content onto the user's body, clothing and/or personal items via a projector and dynamically adapt projection of the media content in the event the user moves within the social setting.

### CROSS-REFERENCE TO RELATED APPLICATIONS

The present non-provisional application claims the benefit of U.S. Provisional Patent Application Ser. No. 61/716,527, filed Oct. 20, 2012, the entire disclosure of which is incorporated herein by reference.

### FIELD

The present disclosure relates to the presentation of media, and, more particularly, to a system for dynamically adapting the presentation of media on a user, including the user's body, clothing and/or personal items (e.g, bag, purse, wallet, etc.).

### BACKGROUND

With ongoing technical advances, access to social media platforms by way of personal computing devices and electronics has become widely available and provides users with increasing means of interacting and sharing information with one another. Social media platforms may include, for example, social network applications, internet forums, weblogs, social blogs, microblogging, wikis and podcasts. Social media platforms generally allow users share information with one another, such as, pictures, videos, music, vlogs, blogs, wall-postings, email, instant messaging, crowdsourcing and voice over IP.

Social media applications may generally involve sharing of content, but are typically used in an individual fashion. Users may capture, share and comment on information using personal electronic devices, such as smartphones, notebook computers, tablet computers, and other similar devices configured to be used individually. For this reason, among others, it has been argued that social media may promote isolation and ultimately discourage face-to-face interaction between users.

Although social media platforms provide users with an alternative means of communication, certain environments generally require face-to-face interaction among one or more persons. For example, some real-world social settings may generally promote face-to-face interaction (e.g. communication) between persons in that setting. Social settings may generally include, for example, a living room of a person's home, waiting rooms, lobbies of hotels and/or office buildings, bars, clubs, coffee houses, etc. where one or more persons may congregate and interact with one another.

In some instances, social media platforms may be of little or no benefit to users in such real-world social settings. For example, some social media platforms allow a user to promote and share content in real, or near-real time, related to, for example, their current status (e.g., their location, mood, opinion on particular topic, etc.) a picture or video of interest, or a news story. However, when in a real-world social setting (e.g. a coffee house) that generally requires face-to-face interaction, persons must necessarily actively engage with another in order to initiate conversation and interaction, rather than completely relying on the passive means of communication afforded by social media platforms. This may be a form of frustration and/or annoyance for some. For example, after initially striking up conversation, if a person would like refer to media of interest, such as media having content related to the conversation (e.g. show a picture having subject matter related to content of the conversation), a person may have to manually engage a media device (e.g. laptop, smartphone, tablet, etc.) in order to obtain such media and related content to show to one another.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for dynamic and adaptive presentation of media on a user consistent with the present disclosure;

FIG. 2 is a block diagram illustrating the system of FIG. 1 in greater detail;

FIG. 3 is a block diagram illustrating the image projection system of FIG. 2 in greater detail;

FIG. 4 is a block diagram illustrating another embodiment of the image projection system of FIG. 2; and

FIG. 5 is a flow diagram illustrating one embodiment for selecting and projecting media onto a user consistent with present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present disclosure is generally directed to a system and method for presenting an image on a user in a social setting. The system may include an image projection system configured to detect the presence of a user via their mobile device when the user comes within a predefined proximity of the image projection system, such as within a real-world social setting (e.g., coffeehouse, bar, club, etc.). The image projection system is further configured to access a social network platform and detect media content associated with the user, particularly media content that the user has shared on the social network platform via their mobile device.

The image projection system may further be configured to project media content onto the user's body, clothing and/or personal items (e.g. bag, purse, wallet, etc.) via a projector. In particular, the projector is configured to project a visual image of the media content onto the user's body, clothing and/or personal items, and dynamically adapt the projection of the media content in the event the user moves within the social setting (i.e. provide real-time, or near real-time, tracking of the user and maintain projection of the media content onto user in accordance with the user's movement about the real-world social setting).

A system consistent with the present disclosure provides a means of dynamically adapting the presentation of social media, such as an image, on a user, thereby providing an alternative means of communication and interaction between a user and other persons in a real-world social setting. A system consistent with the present disclosure provides the user with a personalized display of media content that can be worn on the body, clothing and/or personal items, thereby allowing the user to communicate and promote the content by displaying it as a temporary tattoo-like image, providing a socially-visible form of sharing media content with others. Additionally the system provides a seamless means for people to remain fully engaged with others in a social setting while sharing social media content, thereby enabling a more seamless, ambient, less deliberate means of sharing experiences with others.

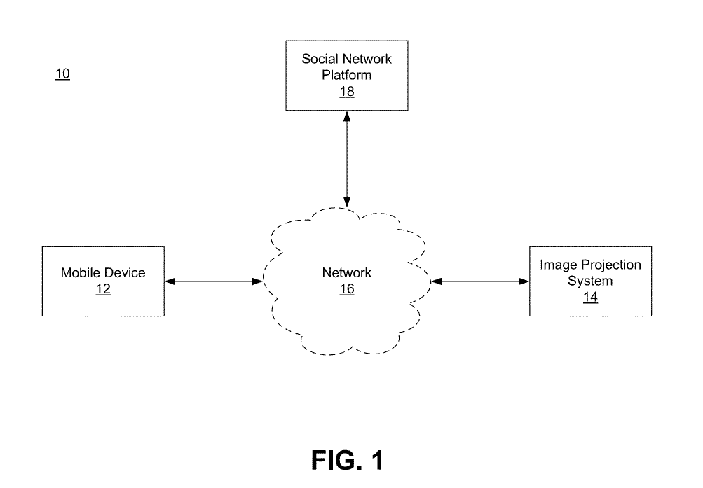

FIG. 1 illustrates one embodiment of a system 10 consistent with the present disclosure. The system 10 includes a mobile device 12, an image projection system 14, and a social network platform 18. As shown, the mobile device 12 and image projection system 14 may be configured to communicate with one another via a network 16. Additionally, the mobile device 12 and image projection system 14 may be configured to each separately communicate with the social network platform 18 via the network 16.

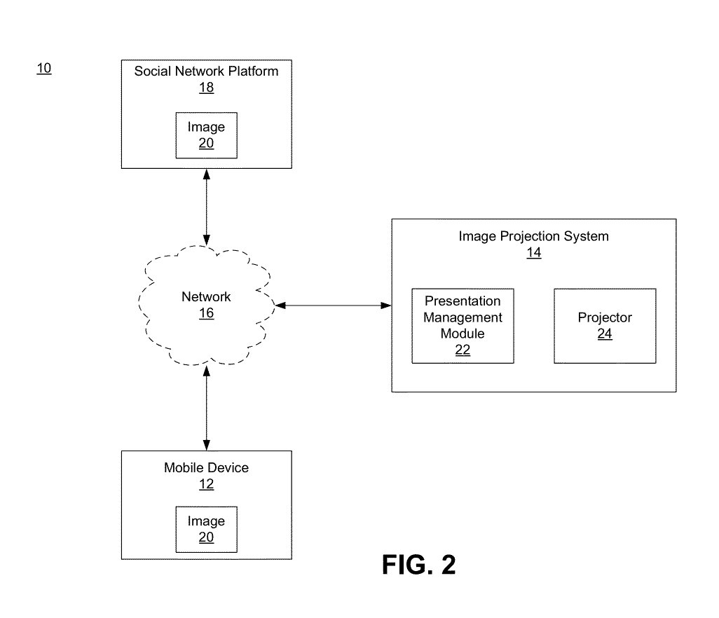

Turning now to FIG. 2, the system 10 of FIG. 1 is illustrated in greater detail. As previously described, the mobile device 12 is configured to communicate with the social network platform 18. A user may use the mobile device 12 to access and exchange information (e.g. upload media content such as images, video, music, etc.) with the social network platform 18 via the network 16. The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, other networks capable of carrying data, and combinations thereof. In some embodiments, network 16 is chosen from the internet, at least one wireless network, at least one cellular telephone network, and combinations thereof.

The mobile device 12 may include, but is not limited to, mobile telephones, smartphones, tablet computers, notebook computers, ultraportable computers, ultramobile computers, netbook computers, subnotebook computers, personal digital assistants, enterprise digital assistants, mobile internet devices and personal navigation devices. Small form factor (SFF) devices, a subset of mobile devices, typically include hand-held mobile devices (i.e., hand-held devices with at least some computing capability). The social network platform 18 may generally refer to a web-based service or platform that provides users with a social network in which to interact and communicate with one another. For example, a social network platform may include, but is not limited to, Facebook, YouTube, Instagram, Twitter, Google+, Weibo, LinkedIn, and MySpace.

In the illustrated embodiment, a user of the mobile device 12 may wish to share media with other users of the social network platform 18. As such, the user may access the social network platform 18 via their mobile device 12 and upload media (e.g., image 20) to the social network platform 18 in order to share and enable other users to view the image 20. Ordinarily, a user would be limited to sharing the image with others via the social network platform 18 within a virtual social setting, wherein, generally only users of the social network platform 18 may be able to view the image 20. As such, in the event that the user traveled to a real-world (as opposed to virtual world) social setting, such as, for example, a coffeehouse, the user could not necessarily share the image 20 with other patrons within the coffeehouse outside of the virtual world method of sharing (via the social network platform 18 over the internet, for example).

However, as described in greater detail herein, the image projection system 14 may be configured to provide a means of presenting the image 20 on the user's body, clothing and/or personal items in the event they are in a real-world social setting. For example, the image projection system 14 may be located in a real-world social setting or environment, including, but not limited to, a living room of a person's home, waiting rooms, lobbies of hotels and/or office buildings, bars, clubs, coffeehouses, museums, as well as public spaces, such as, for example, parks, buildings (e.g. schools and universities), etc. For purposes of clarity and ease of description, the following description will refer to the real-world social setting as a coffeehouse.

The image projection system 14 may include a presentation management module 22 configured to detect the presence of the mobile device 12 and identify the associated user of the mobile device 12. Upon detecting presence of the mobile device 12 and identifying the user, the presentation management module 22 is further configured to access the social network platform 18 and identify a user profile associated with the user and further identify media content associated with the user profile, including, for example, media content uploaded and shared by the user (e.g., image 20).

The presentation management module 22 is further configured to communicate with the user via the mobile device 12 and provide the user with the option of having the image 20 displayed, by way of a projector 24. In the event that the user desires to have the image 20 displayed, the presentation management module 22 is further configured to provide input to the projector 24 so as to control the projection of the image 20 onto a desired surface of the user, including specific regions of the user's body and clothing, or the user's personal items, as will be described in greater detail herein.

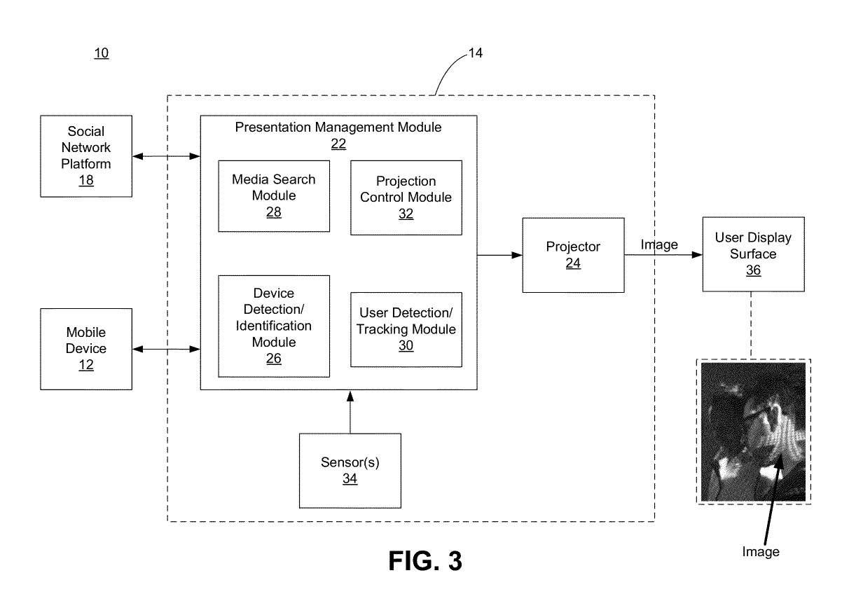

Turning to FIG. 3, the image projection system 14 of FIG. 2 is illustrated in greater detail. As shown, the presentation management module 22 may include a device detection/identification module 26 configured to detect the presence of the mobile device 12 and identify the associated user of the mobile device 12. As previously described, the image projection system 14 and mobile device 12 may communicate with one another using one or more wireless communication protocols including, but not limited to Wi-Fi, 2G, 3G and 4G for network connections, and/or some other wireless signal and/or communication protocol. The image projection system 14 and mobile device 12 may also be configured to communicate with one another via near field communication (NFC), RFID and Bluetooth for near field communication.

The device detection/identification module 26 may include custom, proprietary, known and/or after-developed code (or instruction sets), hardware, and/or firmware that are generally well-defined and operable to detect the presence of a mobile device within a predefined proximity and identify the user of the mobile device. As such, as soon as the user enters the coffeehouse, the device detection/identification module 26 may be configured to detect the presence of the mobile device 12 and associated user. The device detection/identification module 26 may further be configured to prompt the user with one or more options with regard to whether the user would like to connect with and exchange information with the image projection system 14.

If given permission to access information on the user's mobile device 12, the device detection/identification module 26 may be configured to identify one or more social network platforms 18 to which the user is a member. The presentation management module 22 further includes a media search module 28 configured to access one or more identified social network platforms 18 to which the user is a member and search for any media associated with the user, including any recent activity, such as, for example, uploading of images (e.g. image 20).

Upon detecting image 20 (e.g. a recent upload), the presentation management module 22 may further be configured to communicate with the mobile device 12 and prompt the user with the option of having image 20 displayed on their body, clothing and/or personal items, via the projector 24. In one embodiment, the presentation management module 22 may provide the user with one or more display options, including, but not limited to, the region of the body or clothing on which to display the image 20, the size of the image 20, brightness of the image 20, etc. In the event that the user selects to have the image 20 display on their body or clothing, the image 20 is transmitted to the presentation management module 22. It should be noted that, in addition to searching the social network platform 18, the media search module 28 may be configured to search the mobile device 12 for media stored thereon (e.g. images stored on the mobile device 12).

The presentation management module 22 further includes a detection/tracking module 30 and a projection control module 32. The detection/tracking module 30 is configured to receive data captured from at least one sensor 34. A system 10 consistent with the present disclosure may include a variety of sensors configured to capture various attributes of a user associated with the mobile device 12. For example, in the illustrated embodiment, the image projection system 14 includes at least one camera 34 configured to capture one or more digital images of the user of the mobile device 12. The camera 34 includes any device (known or later discovered) for capturing digital images representative of an environment that includes one or more persons, and may have adequate resolution for face and body analysis of a single person in the environment as described herein.

For example, the camera 34 may include a still camera (i.e., a camera configured to capture still photographs) or a video camera (i.e., a camera configured to capture a plurality of moving images in a plurality of frames). The camera 34 may be configured to capture images in the visible spectrum or with other portions of the electromagnetic spectrum (e.g., but not limited to, the infrared spectrum, ultraviolet spectrum, etc.). The camera 34 may include, for example, a web camera (as may be associated with a personal computer and/or TV monitor), handheld device camera (e.g., cell phone camera, smart phone camera (e.g., camera associated with the Apple iPhone, Samsung Galaxy, Palm Treo, Blackberry, etc.), laptop computer camera, tablet computer (e.g., but not limited to, iPad, Galaxy Tab, and the like), e-book reader (e.g., but not limited to, Kindle, Nook, and the like), etc.

The detection/tracking module 30 may be configured to detect the presence of the user in an image, including particular characteristics of the user, such as, for example, specific regions of the user's body (e.g., legs, arms, torso, head, face, etc.). For example, the detection/tracking module 30 may include custom, proprietary, known and/or after-developed feature recognition code (or instruction sets), hardware, and/or firmware that are generally well-defined and operable to receive a standard format image (e.g., but not limited to, a RGB color image) and identify, at least to a certain extent, regions of a user's body in the image. The detection/tracking module 30 may further be configured to detect and identify personal items associated with the user, including, but not limited to, bags, purses, wallets, etc.

The detection/tracking module 30 may be further configured to track movement of the user while the user is within a predefined proximity of the image projection system 14 (i.e. within the coffeehouse). For example, the detection/tracking module 30 may include custom, proprietary, known and/or after-developed location recognition code (or instruction sets), hardware, and/or firmware that are generally well-defined and operable to receive a standard format image (e.g., but not limited to, a RGB color image) and track movement, at least to a certain extent, of identified regions of a user's body in the image. The detection/tracking module 30 may similarly be configured to track movement of an identified personal item associated with the user. Accordingly, the detection/tracking module 30 may be configured to determine and track movement of the user or personal item of the user, as the user moves around within the environment (e.g. coffeehouse).

The projection control module 32 is configured to receive data related to the user characteristics (e.g., identified regions of the user's body, identified personal items, as well as any movement of the user and/or personal items) from the detection/tracking module 32. The projection control module 32 is further configured to communicate with the projector 24 and control projection of the image 20 based on the data related to the user characteristics. As generally understood, the projector 24 may include any known optical image projector configured to project an image (or moving images) onto a surface. In addition to wired communication, the projector 24 may be configured to wirelessly communicate with the presentation management module 22, more specifically the projection control module 32.

The projector 24 may be configured to receive data from the projection control module 30, including the image 20 to be projected and specific parameters of the projection (e.g., particular region of the user's body or clothing, personal item upon which to be projected, size of the projection, brightness of the projection, etc.) and project the image 20 onto a user display surface 36. As shown, the user may wish to have image 20 projected onto the user's neck. In one embodiment, the projector 24 may be configured to project the image 20 on a three-dimensional object, such as, for example the user's neck, with little or no distortion caused by the three-dimensional object. For example, the projector 24 may include custom, proprietary, known and/or after-developed code (or instruction sets), hardware, and/or firmware that are generally well-defined and operable to correct distortion of a projected image.

While the user is within a predefined proximity (within the coffeehouse), the projector 24 is configured to maintain the projection of the image 20 onto the user or associated personal items. During projection of the image 20, the projection control module 32 may be configured to continuously monitor the user and/or personal items and determine any movement of the user and/or personal item in real-time or near real-time. More specifically, the camera 34 may be configured to continuously capture one or more images of the user and the detection/tracking module 30 may continually establish user characteristics (e.g. location of the user and/or personal items within the coffeehouse) based on the one or more images captured. As such, the projection control module 32 may be configured to control positioning of the projection emitted from the projector 24 in real-time or near real-time, as the user may move about the coffeehouse. In the event that the user leaves the coffeehouse, the projector 24 may cease to project the image 20 and communication between the image projection system 14 and the mobile device 12 and social network platform 18 may cease.

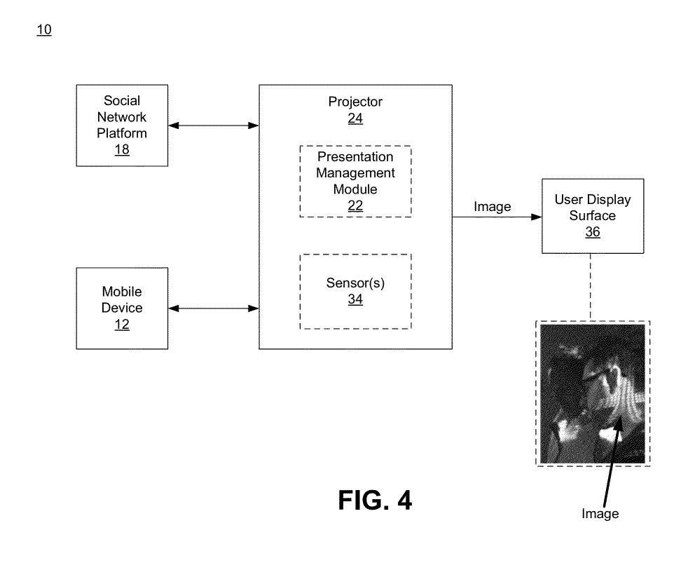

In the illustrated embodiment, the presentation management module 22, projector 24 and at least one camera 34 are separate from one another. It should be noted that in other embodiments, as generally understood by one skilled in the art, the projector 24 may optionally include the presentation management module 22 and/or at least one sensor 34, as shown in FIG. 4, for example. The optional inclusion of presentation management module 22 and/or at least one camera 34 as part of the projector 24, rather than elements external to the projector 24, is denoted in FIG. 4 with broken lines.

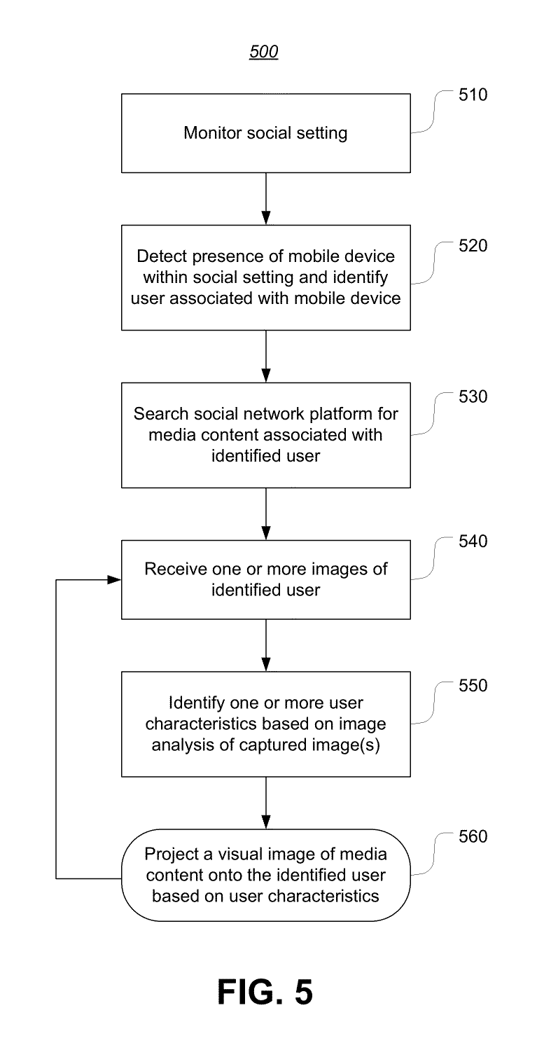

Turning now to FIG. 5, a flowchart of one embodiment of a method 500 for presenting an image on a user in a social setting consistent with the present disclosure is illustrated. The method 500 includes monitoring a social setting (operation 510). The social setting may include, for example, a coffeehouse. The method 500 further includes detecting the presence of a mobile device within the social setting and identifying a user associated with the mobile device (operation 520). The mobile device may be detected by a variety of known means, such as, for example, location-awareness techniques.

The method 500 further includes searching a social network platform for media content associated with the identified user (operation 530). The user may be a member of a social network platform and may use the mobile device to access and interact with others on the social network platform. For example, the user may upload media content, such as an image, to the social network platform via their mobile device. The method 500 further includes receiving one or more images of the identified user (operation 540). The images may be captured using one or more cameras. User characteristics may be identified, including the detection and identification of regions of the user's body within the captured image (operation 550). Additionally, a user's movement within the social setting may also be monitored and tracked.

The method 500 further includes projecting a visual representation of the media content (e.g., image) onto the user based, at least in part, on the user characteristics (operation 560). Movement of the user may be continually monitored such that projection of the media content onto the user may dynamically adapt to the user's movement within the social setting. For example, if the image is projected onto the user's arm, projection of the image will dynamically adapt to the user's movement within the social setting such that the image will continue to be projected onto the user's arm.

While FIG. 5 illustrates method operations according various embodiments, it is to be understood that in any embodiment not all of these operations are necessary. Indeed, it is fully contemplated herein that in other embodiments of the present disclosure, the operations depicted in FIG. 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

A system consistent with the present disclosure provides a means of dynamically adapting the presentation of social media, such as an image, on a user's body, thereby providing an alternative means of communication and interaction between a user and other persons in a social setting. A system consistent with the present disclosure provides the user with a personalized display that can be worn on the body and/or clothing, thereby allowing the user to communicate their appreciation for art and other content by displaying it as a temporary tattoo-like image.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. In one example there is provided a system for projecting a visual representation of media onto a user. The system may include a presentation management module including a device detection and identification module configured to detect the presence of a mobile device within an environment and identify a user associated with the mobile device, a media search module configured to identify media content associated with the user, a user detection and tracking module configured to receive one or more images of the user within the environment and detect and identify one or more characteristics of the user and a projection control module configured to receive data related to the identified media content associated with the user and data related to one or more user characteristics and generate control data based, at least in part, on the received data. The system may further includes a projector configured to receive control data from the projection control module and project a visual representation of the media content on a display surface associated with the user based on the control data.

The above example system may be further configured, wherein the one or more user characteristics are selected from the group consisting of one or more regions of the user's body, movement of the user, including movement of the regions of the user's body, within the environment, personal items associated with the user and movement of the personal items within the environment. In this configuration, the example system may be further configured, wherein the one or more regions of the user's body are selected from the group consisting of head, face, neck, torso, arms, hands, legs and feet. In this configuration, the example system may be further configured, wherein the presentation management module is configured to communicate with the mobile device and allow the associated user to provide input data for controlling one or more parameters of the projection of the visual representation of the media content and the projection control module is configured to receive user input data and generate control data based, at least in part, on the user input data. In this configuration, the example system may be further configured, wherein the one or more parameters are selected from the group consisting of the specific media content of which to project a visual representation of, the region of the user's body upon which to project the visual representation, the personal item upon which to project the visual representation, the size of the visual representation and the brightness of the visual representation.

The above example system may be further configured, alone or in combination with the above further configurations, wherein the projector is configured to maintain projection of the visual representation of the media content on the display surface during movement of the display surface within the environment based on the control data generated by the projection control module.

The above example system may be further configured, alone or in combination with the above further configurations, wherein the projector is configured to project the visual representation of the media content on a three-dimensional surface with little or no distortion caused by the three-dimensional surface.

The above example system may further include, alone or in combination with the above further configurations, a camera configured to capture the one or more images of the user within the environment.

The above example system may be further configured, alone or in combination with the above further configurations, wherein the media search module is configured to access at least one social network platform associated with the user and identify media content associated with the user on the social network platform.

The above example system may be further configured, alone or in combination with the above further configurations, wherein the media search module is configured to access one or more storage mediums associated with the mobile device and identify media content stored therein.

The above example system may be further configured, alone or in combination with the above further configurations, wherein the presentation management module is configured to wirelessly communicate with at least one of the mobile device and projector via a wireless transmission protocol. In this configuration, the example system may be further configured, wherein the wireless transmission protocol is selected from the group consisting of Bluetooth, infrared, near field communication (NFC), RFID and the most recently published versions of IEEE 802.11 transmission protocol standards as of March 2013.

In another example there is provided a method for projecting a visual representation of media onto a user. The method may include monitoring, by a presentation management module, an environment, detecting, by a device detection and identification module, the presence of a mobile device within the environment and identifying a user associated with the mobile device, identifying, by a media search module, media content associated with the user, receiving one or more images of the user within the environment and identifying, by a user detection and tracking module, one or more characteristics of the user in the image, generating, by a projection control module, control data based, at least in part, on the identified media content and the user characteristics and projecting, by a projector, a visual representation of the media content onto a display surface associated with the user based on the control data.

The above example method may be further configured, wherein the one or more user characteristics are selected from the group consisting of one or more regions of the user's body, movement of the user, including movement of the regions of the user's body, within the environment, personal items associated with the user and movement of the personal items within the environment. In this configuration, the example method may further include receiving, by the presentation management module, user input data from the mobile device for controlling one or more parameters of the projection of the visual representation of the media content and generating, by the projection control module, control data based, at least in part, on the user input data. In this configuration, the example method may be further configured, wherein the one or more parameters are selected from the group consisting of the specific media content of which to project a visual representation of, the region of the user's body upon which to project the visual representation, the personal item upon which to project the visual representation, the size of the visual representation and the brightness of the visual representation.

The above example method may be further configured, alone or in combination with the above further configurations, wherein the projector is configured to maintain projection of the visual representation of the media content on the display surface during movement of the display surface within the environment based on the control data generated by the projection control module.

The above example method may be further configured, alone or in combination with the above further configurations, wherein the projector is configured to project the visual representation of the media content on a three-dimensional surface with little or no distortion caused by the three-dimensional surface.

The above example method may further include, alone or in combination with the above further configurations, accessing, by the media search module, at least one social network platform associated with the user and identifying, by the media search module, media content associated with the user on the social network platform.

The above example method may further include, alone or in combination with the above further configurations, accessing, by the media search module, one or more storage mediums associated with the mobile device and identifying, by the media search module, media content stored therein.

In another example there is provided a method for projecting a visual representation of media onto a user. The method may include monitoring, by a presentation management module, an environment, detecting the presence of a mobile device within the environment and identifying a user associated with the mobile device, identifying media content associated with the user, receiving one or more images of the user within the environment and identifying one or more characteristics of the user in the image, generating control data based, at least in part, on the identified media content and the user characteristics and projecting a visual representation of the media content onto a display surface associated with the user based on the control data.

The above example method may be further configured, wherein the one or more user characteristics are selected from the group consisting of one or more regions of the user's body, movement of the user, including movement of the regions of the user's body, within the environment, personal items associated with the user and movement of the personal items within the environment. In this configuration, the example method may further include receiving user input data from the mobile device for controlling one or more parameters of the projection of the visual representation of the media content and generating control data based, at least in part, on the user input data. In this configuration, the example method may be further configured, wherein the one or more parameters are selected from the group consisting of the specific media content of which to project a visual representation of, the region of the user's body upon which to project the visual representation, the personal item upon which to project the visual representation, the size of the visual representation and the brightness of the visual representation.

The above example method may be further configured, alone or in combination with the above further configurations, wherein the projector is configured to maintain projection of the visual representation of the media content on the display surface during movement of the display surface within the environment based on the control data generated by the projection control module.

The above example method may be further configured, alone or in combination with the above further configurations, wherein the projector is configured to project the visual representation of the media content on a three-dimensional surface with little or no distortion caused by the three-dimensional surface.

The above example method may further include, alone or in combination with the above further configurations, accessing at least one social network platform associated with the user and identifying media content associated with the user on the social network platform.

The above example method may further include, alone or in combination with the above further configurations, accessing one or more storage mediums associated with the mobile device and identifying media content stored therein.

In another example, there is provided at least one computer accessible medium storing instructions which, when executed by a machine, cause the machine to perform the operations of any of the above example methods.

In another example, there is provided a system arranged to perform any of the above example methods.

In another example, there is provided a system for projecting a visual representation of media onto a user. The system may include means for monitoring an environment, means for detecting the presence of a mobile device within the environment and identifying a user associated with the mobile device, means for identifying media content associated with the user, means for receiving one or more images of the user within the environment and identifying one or more characteristics of the user in the image, means for generating control data based, at least in part, on the identified media content and the user characteristics and means for projecting a visual representation of the media content onto a display surface associated with the user based on the control data.

The above example system may be further configured, wherein the one or more user characteristics are selected from the group consisting of one or more regions of the user's body, movement of the user, including movement of the regions of the user's body, within the environment, personal items associated with the user and movement of the personal items within the environment. In this configuration, the example system may further include means for receiving user input data from the mobile device for controlling one or more parameters of the projection of the visual representation of the media content and means for generating control data based, at least in part, on the user input data. In this configuration, the example system may be further configured, wherein the one or more parameters are selected from the group consisting of the specific media content of which to project a visual representation of, the region of the user's body upon which to project the visual representation, the personal item upon which to project the visual representation, the size of the visual representation and the brightness of the visual representation.

The above example system may be further configured, alone or in combination with the above further configurations, wherein the projector is configured to maintain projection of the visual representation of the media content on the display surface during movement of the display surface within the environment based on the control data generated by the projection control module.

The above example system may be further configured, alone or in combination with the above further configurations, wherein the projector is configured to project the visual representation of the media content on a three-dimensional surface with little or no distortion caused by the three-dimensional surface.

The above example system may further include, alone or in combination with the above further configurations, means for accessing at least one social network platform associated with the user and means for identifying media content associated with the user on the social network platform.

The above example system may further include, alone or in combination with the above further configurations, means for accessing one or more storage mediums associated with the mobile device and means for identifying media content stored therein.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system for projecting a visual representation of media onto a user, said system comprising:
a presentation management module comprising:
a device detection module configured to detect the presence of a mobile device and identify a user associated with said mobile device;
a media search module configured to identify media content associated with said user;
a user tracking module configured to receive one or more images of said user and identify one or more characteristics of said user; and
a projection control module configured to receive data related to said identified media content and to one or more user characteristics and generate control data based, at least in part, on said received data; and
a projector configured to receive control data and project a visual representation of said media content on a display surface associated with said user based on said control data.

2. The system of claim 1, wherein said one or more user characteristics are selected from the group consisting of one or more regions of said user's body, movement of said user, including movement of said regions of said user's body, within said environment, personal items associated with said user and movement of said personal items within said environment.

3. The system of claim 2, wherein said one or more regions of said user's body are selected from the group consisting of head, face, neck, torso, arms, hands, legs and feet.

4. The system of claim 2, wherein said presentation management module is configured to communicate with said mobile device and allow said associated user to provide input data for controlling one or more parameters of said projection of said visual representation of said media content and said projection control module is configured to receive user input data and generate control data based, at least in part, on said user input data.

5. The system of claim 4, wherein said one or more parameters are selected from the group consisting of the specific media content of which to project a visual representation of, the region of said user's body upon which to project said visual representation, the personal item upon which to project said visual representation, the size of said visual representation and the brightness of said visual representation.

6. The system of claim 1, wherein said projector is configured to maintain projection of said visual representation of said media content on said display surface during movement of said display surface within said environment based on said control data generated by said projection control module.

7. The system of claim 1, wherein said projector is configured to project said visual representation of said media content on a three-dimensional surface with little or no distortion caused by said three-dimensional surface.

8. The system of claim 1, further comprising a camera configured to capture said one or more images of said user within said environment.

9. The system of claim 1, wherein said media search module is configured to access at least one social network platform associated with said user and identify media content associated with said user on said social network platform.

10. The system of claim 1, wherein said media search module is configured to access one or more storage mediums associated with said mobile device and identify media content stored therein.

11. The system of claim 1, wherein said presentation management module is configured to wirelessly communicate with at least one of said mobile device and projector via a wireless transmission protocol.

12. The system of claim 11, wherein said wireless transmission protocol is selected from the group consisting of Bluetooth, infrared, near field communication (NFC), RFID and the most recently published versions of IEEE 802.11 transmission protocol standards as of March 2013.

13. At least one computer accessible medium storing instructions which, when executed by a machine, cause the machine to perform operations for projecting a visual representation of media onto a user, said operations comprising:
detecting the presence of a mobile device and identifying a user associated with said mobile device;
identifying media content associated with said user;
receiving one or more images of said user and identifying one or more characteristics of said user in said image;
generating control data based, at least in part, on said identified media content and said user characteristics; and
projecting a visual representation of said media content onto a display surface associated with said user based on said control data.

14. The computer accessible medium of claim 13, wherein said one or more user characteristics are selected from the group consisting of one or more regions of said user's body, movement of said user, including movement of said regions of said user's body, within said environment, personal items associated with said user and movement of said personal items within said environment.

15. The computer accessible medium of claim 14, further comprising receiving user input data from said mobile device for controlling one or more parameters of said projection of said visual representation of said media content and generating control data based, at least in part, on said user input data.

16. The computer accessible medium of claim 15, wherein said one or more parameters are selected from the group consisting of the specific media content of which to project a visual representation of, the region of said user's body upon which to project said visual representation, the personal item upon which to project said visual representation, the size of said visual representation and the brightness of said visual representation.

17. The computer accessible medium of claim 13, further comprising accessing at least one social network platform associated with said user and identifying media content associated with said user on said social network platform.

18. The computer accessible medium of claim 13, further comprising accessing one or more storage mediums associated with said mobile device and identifying media content stored therein.

19. A method for projecting a visual representation of media onto a user, said method comprising:
detecting, by a device detection module, the presence of a mobile device and identifying a user associated with said mobile device;
identifying, by a media search module, media content associated with said user;
receiving one or more images of said user and identifying, by a user tracking module, one or more characteristics of said user in said image;
generating, by a projection control module, control data based, at least in part, on said identified media content and said user characteristics; and
projecting, by a projector, a visual representation of said media content onto a display surface associated with said user based on said control data.

20. The method of claim 19, wherein said one or more user characteristics are selected from the group consisting of one or more regions of said user's body, movement of said user, including movement of said regions of said user's body, within said environment, personal items associated with said user and movement of said personal items within said environment.

21. The method of claim 20, further comprising receiving, by said presentation management module, user input data from said mobile device for controlling one or more parameters of said projection of said visual representation of said media content and generating, by said projection control module, control data based, at least in part, on said user input data.

22. The method of claim 21, wherein said one or more parameters are selected from the group consisting of the specific media content of which to project a visual representation of, the region of said user's body upon which to project said visual representation, the personal item upon which to project said visual representation, the size of said visual representation and the brightness of said visual representation.

23. The method of claim 19, wherein said projector is configured to maintain projection of said visual representation of said media content on said display surface during movement of said display surface within said environment based on said control data generated by said projection control module.

24. The method of claim 19, wherein said projector is configured to project said visual representation of said media content on a three-dimensional surface with little or no distortion caused by said three-dimensional surface.

25. The method of claim 19, further comprising accessing, by said media search module, at least one social network platform associated with said user and identifying, by said media search module, media content associated with said user on said social network platform.
